(19) United States
(12) Patent Application Publication
(10) Pub. No.: US 2012/0167927 A1
(43) Pub. Date: Jul. 5, 2012

(54) DISHWASHER

(76) Inventors: Yongho SHIN, Seoul (KR); Moonkee CHUNG, Seoul (KR); Joonho PYO, Seoul (KR)

(21) Appl. No.: 13/339,625

(22) Filed: Dec. 29, 2011

(30) Foreign Application Priority Data
Dec. 31, 2010 (KR) 10-2010-0140524

(51) Int. Cl. A47L 15/26; B08B 3/02; A47L 15/50

(52) U.S. Cl. 134/103.3; 134/200; 134/151; 134/145; 134/103.2

(57) ABSTRACT

A dishwasher is disclosed. The dishwasher includes a tub to provide a washing space, a dish rack positioned in the washing space, to receive washing objects therein, a spraying arm to spray washing water toward the washing objects received in the dish rack, a supply path to provide washing water to the spraying arm, and a rack spraying arm provided in the dish rack, in communication with the supply path, to spray the washing water only to predetermined washing objects received in the rack. As a result, the dishwasher may realize an effect of intensive washing performed for washing objects with a high contamination level.

### CROSS-REFERENCE TO RELATED APPLICATION

This application claims priority under 35 U.S.C. §119(a) from Korean Application No. 10-2010-0140524 filed on Dec. 31, 2010, the subject matter of which is incorporated herein by reference.

### BACKGROUND

1. Field

Embodiments may relate to a dishwasher, more particularly to, a dishwasher capable of additionally and intensively spraying washing water toward a predetermined area of a rack having washing objects placed thereon such as dishes and tools used in cooking.

2. Background

Dishwashers are electric appliances used for spraying detergent and washing water toward dishes and tools used in cooking (hereinafter, “washing objects”) to wash off food scraps and refuse from washing objects.

Typically, a conventional dishwasher may include a tub to provide a washing room, a dish rack provided in the tub to place washing objects thereon, a spraying arm to spray washing water to the dish rack, a sump to store the washing water and a supply path to supply the washing water stored in the sump to the spraying arm.

Such a dishwasher having the above configuration may spray the washing water to the washing objects placed on the dish rack via the spraying arm, based on a washing course selected by a user, to contaminate food scraps from the washing objects. After that, the washing objects having the food scraps removed there from may be dried by hot air.

In the meanwhile, contamination levels of the washing objects placed on the dish rack of the dishwasher may be various and it is difficult to wash washing objects with a relatively high contamination level and the other washing objects with a relatively low contamination levels in the same washing course.

In other words, if the dishwasher is put into operation based on a washing course suitable for the washing objects with the low contamination level, there might be a disadvantage of failing in washing the washing objects with the high contamination level satisfactorily. If it is put into operation based on a washing course suitable for the washing objects with the high contamination level, there might be a disadvantage of energy waste.

### SUMMARY

Accordingly, the embodiments may be directed to a dishwasher. To solve the problems, an object of the embodiments may be to provide a dishwasher which is able to intensively wash washing objects with a high contamination level.

A further object of the embodiments may be to provide a dishwasher including a rack spraying arm to spray washing water only to a predetermined area of a dish rack accommodating washing objects therein.

To achieve these objects and other advantages and in accordance with the purpose of the embodiments, as embodied and broadly described herein, a dishwasher may include a tub to provide a washing space; a dish rack positioned in the washing space, to receive washing objects therein; a spraying arm to spray washing water toward the washing objects received in the dish rack; a supply path to provide washing water to the spraying arm; and a rack spraying arm provided in the dish rack, in communication with the supply path, to spray the washing water only to predetermined washing objects received in the rack.

The dish rack may be withdrawable from the washing space to the outside of the tub, and the rack spraying arm may be detachably provided below the dish rack.

The rack spraying arm may be separated from the supply path as the dish rack is withdrawn from the tub, and the rack spraying arm may be moving together with the dish rack as the dish rack is getting withdrawn.

The dishwasher may further include an auxiliary rack positioned beyond the rack spraying arm, the auxiliary rack detachable from the dish rack.

The rack spraying arm may include a nozzle to spray washing water toward washing objects received in the auxiliary rack.

The nozzle may be slope a predetermined angle from a bottom surface of the auxiliary rack.

The rack spraying arm may be provided in an edge of a bottom surface of the dish rack, the edge in contact with the supply path.

The rack spraying arm may be extended along a rim of an accommodation space provided in the dish rack.

According to another embodiment of the present invention, a dishwasher includes a tub to provide a washing space; a dish rack positioned in the washing space, to receive washing objects therein; a supply path to provide washing water; an upper spraying arm provided beyond the dish rack, in communication with the supply path, to spray washing water from beyond the dish rack; a lower spraying arm provided below the dish rack, in communication with the supply path, to spray the washing water from below the dish rack; and a rack spraying arm provided below the dish rack to spray the washing water to an area different from an area to which the washing water is sprayed by the upper and lower spraying arms.

The upper and lower spraying arm may be rotatable.

The rack spraying arm may be positioned outside a rotational radius of the upper and lower spraying arm.

The dish rack may be withdrawable from the washing space to the outside of the tub, and the rack spraying arm may be detachably provided below the dish rack.

The rack spraying arm may be separated from the supply path as the dish rack is withdrawn from the tub, and the rack spraying arm may be moving together with the dish rack as the dish rack is getting withdrawn.

The dishwasher may further include an auxiliary rack positioned beyond the rack spraying arm, the auxiliary rack detachable from the dish rack.

The rack spraying arm may include a nozzle to spray washing water toward washing objects received in the auxiliary rack.

The nozzle may be slope a predetermined angle from a bottom surface of the auxiliary rack.

The rack spraying arm may be provided in an edge of a bottom surface of the dish rack, the edge in contact with the supply path.

The rack spraying arm may be extended along a rim of an accommodation space provided in the dish rack.

The embodiments have following advantageous effects. The dishwasher according to the embodiments may include the rack spraying part to spray washing water only to a predetermined area of the dish rack having washing objects placed therein. Because of that, intensive washing may be performed advantageously.

Furthermore, the dishwasher may advantageously and effectively wash objects with a relatively high contamination level and washing objects with a relatively low contamination level by differentiating the amount of washing water sprayed toward the washing objects based on the contamination level.

It is to be understood that both the foregoing general description and the following detailed description of the embodiments or arrangements are exemplary and explanatory and are intended to provide further explanation of the embodiments as claimed.

### BRIEF DESCRIPTION OF THE DRAWINGS

Arrangements and embodiments may be described in detail with reference to the following drawings in which like reference numerals refer to like elements and wherein:

FIG. 1 is a conceptual diagram illustrating a dishwasher according to an exemplary embodiment;

FIG. 2 is a perspective view partially illustrating a dish rack and a rack spraying, which are provided in the dishwasher according to the embodiment;

FIG. 3 is a plane view illustrating an embodiment of the rack spraying part provided in the dishwasher;

FIG. 4 is a plane view illustrating another embodiment of the rack spraying part provided in the dishwasher; and

FIG. 5 is a diagram illustrating positions of an auxiliary rack and a rack spraying part that are provided in the dishwasher.

### DETAILED DESCRIPTION

Reference may now be made in detail to specific embodiments, examples of which may be illustrated in the accompanying drawings. Wherever possible, same reference numbers may be used throughout the drawings to refer to the same or like parts.

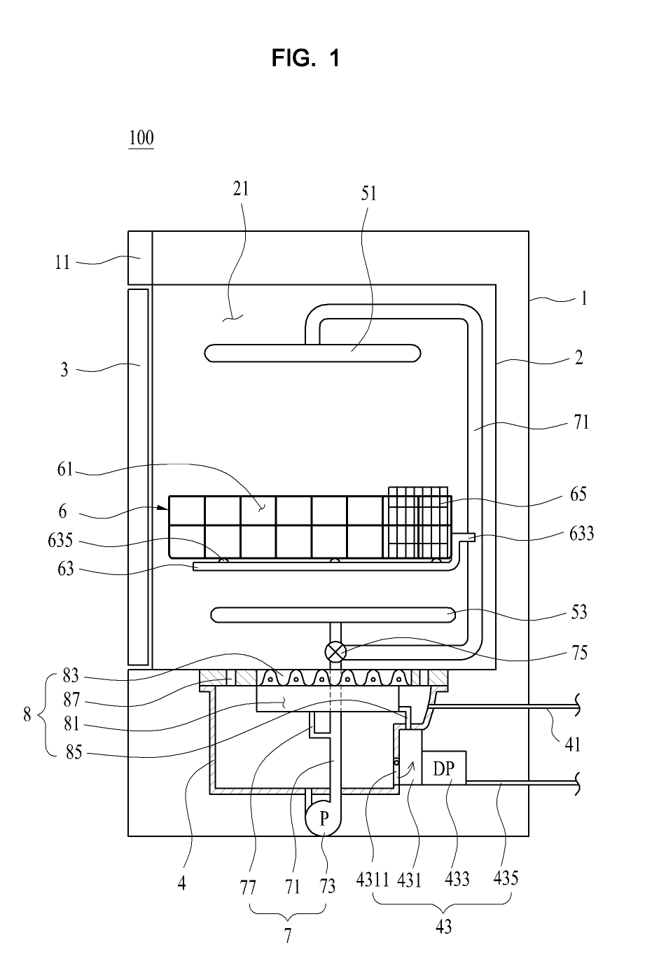

In reference to FIG. 1, a basic structure of a dishwasher according to an exemplary embodiment will be described.

The dishwasher 100 according to the embodiment may include a cabinet 1 to define an exterior appearance thereof and a tub 2 provided in the cabinet to provide a washing room.

A door 3 may be coupled to the cabinet 1 to enable a user to open and close the washing space 21 provided in the tub selectively. A control panel 11 may be further provided on an outer surface of the door or the cabinet to enable the user to select the operation of the dishwasher 100.

A sump 4 may be further provided underneath the tub 20 to store washing water. The sump 4 may be in communication with a water supply part 41 and a water drainage part 43.

The water supply part 41 may be a configuration provided to supply the washing water to wash washing objects such as dishes. The water supply part 41 may be a water supply hose (not shown) configured to connect a water supply source (not shown) provided outside the dishwasher 100 and the sump 4 with each other. The water drainage part 43 may be a configuration provided to drain the washing water stored in the sump 4 outside the dishwasher 100. The water drainage part 43 may include a drainage pump 433 and a drainage hose 435.

A side of the drainage pump 433 may be in communication with the sump 4 and the other opposite side of the drainage pump 433 may be in communication with the drainage hose 435. When the drainage pump 433 is put into operation, the washing water stored in the sump 4 may be exhausted outside the dishwasher 100 via the drainage hose 435.

In the meanwhile, the water drainage part 43 may further include a drainage chamber 431 to receive the drainage pump 433 therein. The drainage chamber 431 may be in communication with the sump 4 via a check valve 4311 and it may be in communication with a filter unit 8, which will be described in detail later.

The dishwasher 100 according to the embodiment may further include a dish rack 6 provided in the tub 2 to receive the washing objects therein, a spraying arm 51 and 53 to spray the washing water toward the dish rack 6 and a washing water supply part 7 to supply the washing water to the spraying arm 51 and 53.

The dish rack 6 may be positioned in the washing space 21 to provide a predetermined space where the washing objects are received. When opening the door 3, the user may withdraw the dish rack 6 from the washing space 21.

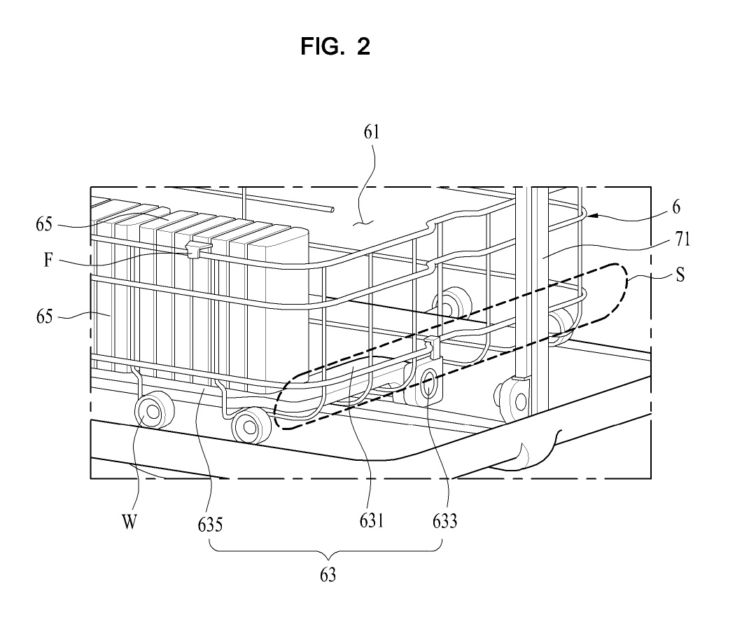

A plurality of wheels (W, see FIG. 2) may be provided in the dish rack 6 to assist the dish rack 6 to be withdrawable from the washing space 21 smoothly. In this case, a rail (no shown) may be further provided in the tub 2 to support the wheels (W).

The spraying arm 51 and 53 may be connected with the washing water supply part 7 in communication with the sump 4. at this time, the spraying arm 51 and 53 may include either or both of an upper spraying arm 51 to spray the washing water to an upper area of the dish rack 6 and a lower spraying arm 53 to spray the washing water toward a lower area of the dish rack 6.

Here, it may be assumed that the dishwasher 100 according to the embodiment includes both of the upper and lower spraying arms 51 and 53 for convenience sake as follows.

In the meanwhile, the washing water supply part 7 may be configured to supply the washing water stored in the sump 4 to the upper and lower spraying arms 51 and 53. The washing water supply part 7 may include a supply path 71 and a pump 73.

In this case, the upper spraying arm 51 and the lower spraying arm 53 may be connected with the pump 73 along the supply path 71. The pump 73 may press the washing water stored in the sump 4 to supply the washing water to each of the upper and lower spraying arms 51 and 53.

The supply path 71 may be configured of two independent paths connected with the upper and lower spraying arms 51 and 53, respectively. It may be preferable that a single supply path 71 is branched to be connected with each of the upper and lower spraying arms 51 and 53, as shown in FIG. 1. In this case, a diverter valve 75 may be further provided at a branched point of the supply path 71 to selectively supply the washing water to the upper spraying arm 51 and the lower spraying arm 53.

As a result, the washing water pressed by the pump 73 may be supplied to either of the upper spraying arm 51 and the lower spraying arm 53 or both of them simultaneously, via the diverter valve 75.

In the meanwhile, the dishwasher 100 according to the embodiment may further include a filter unit 8 to filter foreign matters contained in the washing water. The filter unit 8 may include a chamber 81 to receive the washing water, a filter 83 provided at a top of the chamber 81, a contaminant outlet 85 to make the chamber 81 communicate with the drainage chamber 431, and a collecting hole 87. In this case, a filtering path 77 in communication with the chamber 81 may be further provided in the supply path.

According to the dishwasher 100 having the configuration mentioned above, the washing water may be supplied to the sump 4 via the water supply part 41. The supplied washing water may be supplied to the upper spraying arm 51 and the lower spraying arm 53 via the pump 73 and the supply path 71.

In the meanwhile, the washing water sprayed toward the washing objects placed in the dish rack 6 via the upper spraying arm 51 and the lower spraying arm 53 may be collected in the sump 4 via the collecting hole 87 provided in the filter unit 8. A predetermined amount of the washing water supplied to the upper spraying arm 51 and the lower spraying arm 53 via the supply path 71 may be supplied to the chamber 81 of the filter unit 8 via the filtering path 77.

The washing water supplied to the chamber 81 may be collected in the sump 4 via the collecting hole 87, after passing through the filter 83 provided at the top of the chamber 81. However, contaminants such as food scraps contained in the washing water cannot pass through the filter 83 and they may be stored in the chamber 81.

As a result, the dishwasher 100 including the filter unit 8 may performing the filtering of the washing water collected in the sump 4 and the washing of the dishes simultaneously.

In the meanwhile, the contaminants stored in the chamber 81 may be discharged together with the washing water stored in the sump 4. The process of the discharge will be described as follows.

The drainage chamber 431 where the drainage pump 433 is provided may be in communication with the chamber 81 via the contaminant outlet 85 as well as with the sump 4 via the check valve 4311.

The check valve 4311 may be rotatable toward the inside of the drainage chamber 431 but not toward the sump 4. Because of that, when the drainage pump 433 is put into operation, the washing water stored in the sump 4 may be discharged outside the dishwasher 100 via the check valve 4311, the drainage pump 433 and the drainage hole 435.

In addition, when the drainage pump 433 is put into operation, a relatively low pressure may be formed in the drainage chamber 431. Because of that, the contaminants stored in the chamber 81 of the filter unit 8 may be moved into the drainage chamber 431 via the contaminant outlet 85. After that, the washing water inside the drainage chamber 431 may be discharged outside the dishwasher 100, together with the washing water discharged from the sump 4.

In the meanwhile, according to the dishwasher 100 including the configuration mentioned above, a plurality of nozzles (not shown) may be provided in the upper spraying arm 51 and the lower spraying arm 53. Even if the spraying arms and 53 are rotated during the spraying of the washing water, washing performance might be differentiated based on a contamination level of the washing objects stored in the dish rack 6.

In other words, in case a contamination level of the washing objects placed in the dish rack 6 is high even if the washing water is sprayed by the rotating spraying arms 51 and 53, a relatively low washing performance may be implemented in comparison to washing performance of the washing objects with a relatively low contamination level. This may cause user dissatisfaction.

To overcome that problem, a washing course set to wash dishes with a high contamination level may be selected (selected via the control panel 11) and the dishwasher 100 may be put into operation based on the selected washing course. If then, a problem of energy waste might arise. As a result, the embodiment may provide the dishwasher 100 including a rack spraying arm 63 to spray washing water only toward a predetermined area of the dish rack 6. In other words, the dishwasher 100 according to the embodiment may overcome that problem by spraying the washing water only toward washing objects with a relatively high contamination level via the rack spraying arm 63.

The dish rack 6 provided in the dishwasher according to the embodiment may include an accommodating space 61 to accommodate the washing objects and a rack spraying arm 63 detachable from a bottom surface of the dish rack 6. As follows, the rack spraying arm 63 will be described in reference to FIG. 2. The rack spraying arm 63 may include a path 631 to supply washing water, a detaching valve 633 to connect the path 631 with the supply path 71, and a nozzle 635 spray the washing water supplied via the path 631.

As mentioned above, the dish rack 6 may be withdrawn from the washing space 21 of the tub 2 or inserted in the washing space 21 (see an arrow line).

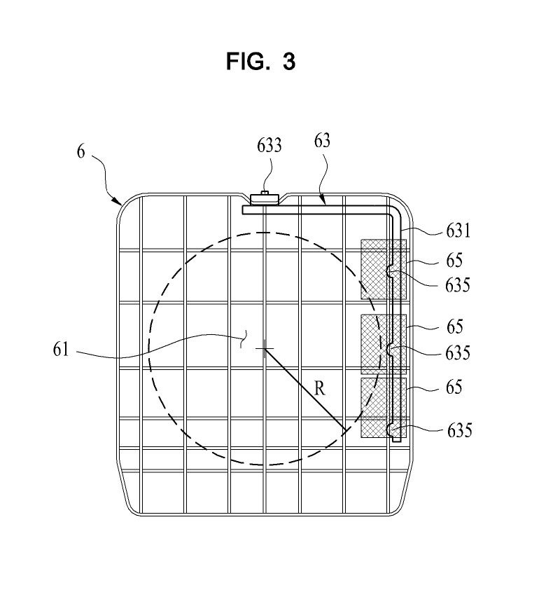

As a result, when the user may withdraw the dish rack 6 from the washing space via the detaching valve 633, the path 631 may be separated from the supply path 71. When the user insertedly positions the dish rack 6 in the washing space, the path 631 may be connected with the supply path 71. In the meanwhile, the path 631 may be provided in a lower area of the dish rack 6 as shown in FIG. 3 and it is preferable that the path 631 is arranged along a rim of the dish rack 6 (that is, along an outer surface or an outer circumferential surface).

As shown in FIG. 3, the lower spraying arm 53 may spray the washing water, while being rotated. Because of that, there might be a disadvantage of the rack spraying arm 63 interference with the washing water sprayed from the lower spraying arm 53, when the rack spraying arm 63 is positioned in a rotational radius of the lower spraying arm 53. As a result, the washing water sprayed from the lower spraying arm 53 fails to be supplied to the washing objects.

To prevent the deterioration of washing efficiency mentioned above, the rack spraying arm 63 may be arranged in an edge of the washing object accommodating space 61 provided in the dish rack 6, as shown in FIG. 3.

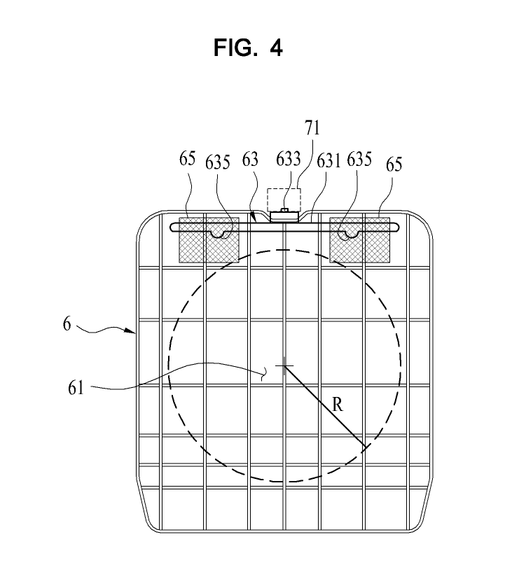

FIG. 4 illustrates another embodiment of the rack spraying arm 63. The rack spraying arm 63 shown in FIG. 4 may be provided in a flat surface contacting with the supply path 71, in an edge of the bottom of the accommodating space 61 formed in the dish rack 6.

In other words, there may be four edges formed in the bottom of the accommodating space 61 provided in the dish rack 6 formed in a case shape. The rack spraying arm 63 may be provided in one of the edges that contacts with the supply path 71 or that accommodates the supply path 71 (see, FIG. 2). This is because deterioration of a spray pressure possessed by the washing water sprayed from the rack spraying arm 63 has to be minimized.

The pressure of the washing water supplied to the path 631 from the supply path 71 may be uniform. Because of that, as the path 631 of the rack spraying arm 63 is getting longer and longer, the pressure of the washing water (that is, the spray pressure) sprayed from a nozzle 635 of the rack spraying arm 63 may be getting lower and lower as shown in FIG. 3.

As a result, the path 631 provided in the rack spraying arm 63 may be set shorter. When the rack spraying arm 63 is positioned in the flat surface not interfering with the rotational radius (R) of the lower spraying arm 53, the deterioration of the spray pressure of the washing water sprayed via the nozzle 635 may be reduced as much as possible and deterioration of washing efficiency may be prevented. The position capable of realizing the effect may be the edge that accommodates (or contacts) the supply path 71 out of the bottom surface edges of the accommodating space 61.

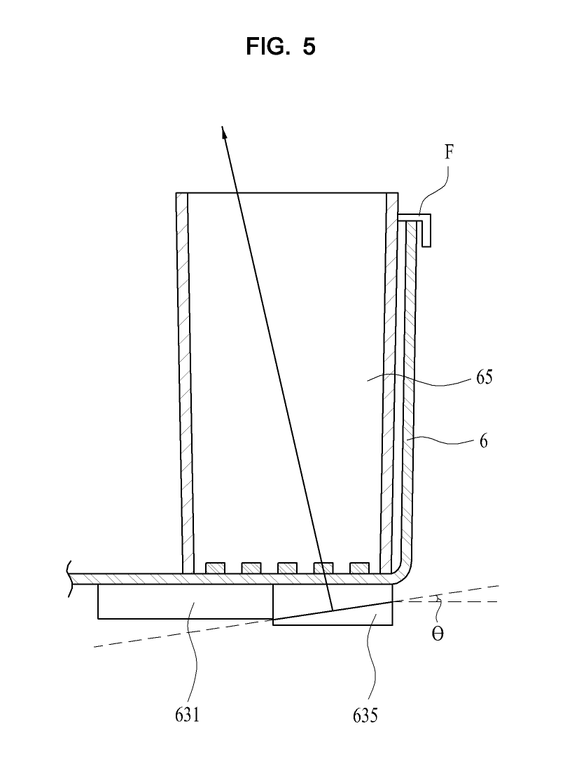

Moreover, the dishwasher 100 according to the embodiment may further include an auxiliary rack 65 that is detachable from the dish rack 6 as shown in FIGS. 1 and 5.

In this case, the auxiliary rack 65 may be detachable via detaching means (F, see FIG. 2) provided in a top of the dish rack 6, positioned beyond the rack spraying arm 63.

As a result, the washing water sprayed from the rack spraying arm 63 in the washing process may be sprayed only toward the auxiliary rack 65 only when the user places washing objects with a high contamination level. Because of that, the washing objects with the high contamination level may be intensively washed.

In the meanwhile, when the auxiliary rack 65 is detachably provided in the accommodating space 61 of the dish rack 6, the nozzle 635 provided in the rack spraying arm 63 may be slope a preset angle as shown in FIG. 5.

More specifically, the nozzle 635 may be slope a preset angle from a bottom surface of the auxiliary rack 65. The washing water may be obliquely sprayed toward the washing objects accommodated in the auxiliary rack 65, which may generate an effect of improved washing efficiency.

Moreover, when top and bottom surfaces of the auxiliary rack 65 are formed in a lattice shape, there may be an effect of intensive washing for cutlery such as forks, knifes and spoons.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A dishwasher comprising:
a tub to provide a washing space;
a dish rack positioned in the washing space, to receive washing objects therein;
a spraying arm to spray washing water toward the washing objects received in the dish rack;
a supply path to provide washing water to the spraying arm; and
a rack spraying arm provided in the dish rack, in communication with the supply path, to spray the washing water only to predetermined washing objects received in the rack.

2. The dishwasher according to claim 1, wherein the dish rack is withdrawable from the washing space to the outside of the tub, and the rack spraying arm is detachably provided below the dish rack.

3. The dishwasher according to claim 2, wherein the rack spraying arm is separated from the supply path as the dish rack is withdrawn from the tub, and the rack spraying arm is moving together with the dish rack as the dish rack is getting withdrawn.

4. The dishwasher according to claim 1, further comprising:
an auxiliary rack positioned beyond the rack spraying arm, the auxiliary rack detachable from the dish rack.

5. The dishwasher according to claim 4, wherein the rack spraying arm comprises a nozzle to spray washing water toward washing objects received in the auxiliary rack.

6. The dishwasher according to claim 5, wherein the nozzle is slope a predetermined angle from a bottom surface of the auxiliary rack.

7. The dishwasher according to claim 1, wherein the rack spraying arm is provided in an edge of a bottom surface of the dish rack, the edge in contact with the supply path.

8. The dishwasher according to claim 1, wherein the rack spraying arm is extended along a rim of an accommodation space provided in the dish rack.

9. A dishwasher comprising:
a tub to provide a washing space;
a dish rack positioned in the washing space, to receive washing objects therein;
a supply path to provide washing water;
an upper spraying arm provided beyond the dish rack, in communication with the supply path, to spray washing water from beyond the dish rack;
a lower spraying arm provided below the dish rack, in communication with the supply path, to spray the washing water from below the dish rack; and
a rack spraying arm provided below the dish rack to spray the washing water to an area different from an area to which the washing water is sprayed by the upper and lower spraying arms.

10. The dishwasher according to claim 9, wherein the upper and lower spraying arm are rotatable.

11. The dishwasher according to claim 10, wherein the rack spraying arm is positioned outside a rotational radius of the upper and lower spraying arm.

12. The dishwasher according to claim 9, wherein the dish rack is withdrawable from the washing space to the outside of the tub, and the rack spraying arm is detachably provided below the dish rack.

13. The dishwasher according to claim 12, wherein the rack spraying arm is separated from the supply path as the dish rack is withdrawn from the tub, and the rack spraying arm is moving together with the dish rack as the dish rack is getting withdrawn.

14. The dishwasher according to claim 9, further comprising:
an auxiliary rack positioned beyond the rack spraying arm, the auxiliary rack detachable from the dish rack.

15. The dishwasher according to claim 14, wherein the rack spraying arm comprises a nozzle to spray washing water toward washing objects received in the auxiliary rack.

16. The dishwasher according to claim 15, wherein the nozzle is slope a predetermined angle from a bottom surface of the auxiliary rack.

17. The dishwasher according to claim 9, wherein the rack spraying arm is provided in an edge of a bottom surface of the dish rack, the edge in contact with the supply path.

18. The dishwasher according to claim 9, wherein the rack spraying arm is extended along a rim of an accommodation space provided in the dish rack.
